(19) United States
(12) Patent Application Publication
(10) Pub. No.: US 2009/0051655 A1
(43) Pub. Date: Feb. 26, 2009

(54) MOUSE WITH TELEVISION SIGNAL RECEIVING FUNCTION

(75) Inventor: Chun-Kai CHAN, Taipei (TW)

Correspondence Address: Muncy, Geissler, Olds & Lowe, PLLC, P.O. BOX 1364, FAIRFAX, VA, 22038-1364, US

(73) Assignee: ASUSTeK COMPUTER INC.

(21) Appl. No.: 12/196,801

(22) Filed: Aug. 22, 2008

(30) Foreign Application Priority Data
Aug. 23, 2007 (TW) 96131302

(51) Int. Cl. G06F 3/033

(52) U.S. Cl. 345/163

(57) ABSTRACT

A mouse with television signal receiving function includes a mouse casing, a vent hole disposed on the mouse casing, and a digital tuner, an antenna, a hub disposed in the mouse casing. The vent hole is arranged near the digital tuner. The antenna connects to the digital tuner for receiving a digital television signal. The hub has a first port and a second port. The first port is connected with a mouse control unit. The second port is connected with the digital tuner.

### RELATED APPLICATIONS

This application claims priority to Taiwan Application Serial Number 96131302, filed Aug. 23, 2007, which is herein incorporated by reference.

### BACKGROUND

1. Field of Invention

The present invention relates to a mouse. More particularly, the present invention relates to a mouse with television signal receiving function.

2. Description of Related Art

Computers and their peripherals have become very popular in recent years. The functions and varieties of computer peripherals have increased. For example, using a computer to receive and display TV signals has become a popular computer application. Once a television card (TV card) is applied to a computer, cable or wireless TV program signals can be transformed into signals that can be displayed by a computer such that a computer user does not have to buy an extra TV for watching TV programs.

### SUMMARY

The invention provides a mouse with television signal receiving function, which includes a mouse casing, a vent hole disposed on the mouse casing, and a digital tuner, an antenna, a hub disposed in the mouse casing. The vent hole is arranged near the digital tuner. The antenna connects to the digital tuner for receiving a digital television signal. The hub has a first port and a second port. The first port is connected with a mouse control unit. The second port is connected with the digital tuner.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a top view diagram of a first embodiment of the mouse with television signal receiving function of the invention;

FIG. 1B is a side view diagram of the first embodiment of the mouse with television signal receiving function of the invention;

FIG. 2 is a schematic diagram of a second embodiment of the mouse with television signal receiving function of the invention;

FIG. 3 is a schematic diagram of a third embodiment of the mouse with television signal receiving function of the invention; and

FIG. 4 is a schematic diagram of a fourth embodiment of the mouse with television signal receiving function of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

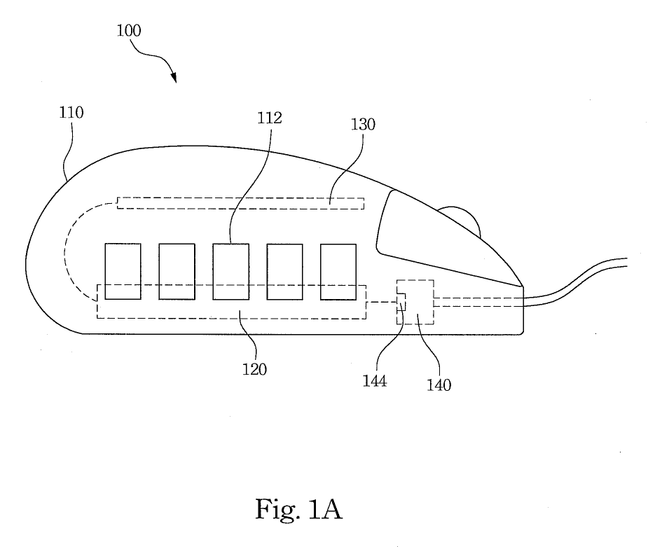

Refer to FIG. 1A and FIG. 1B simultaneously. FIG. 1A and FIG. 1B illustrate a top view diagram and a side view diagram of a first embodiment of the mouse with television signal receiving function of the invention. The mouse 100 includes a mouse casing 110, a digital tuner 120, a plane antenna 130, a hub 140, and a mouse control unit 150. The digital tuner 120, the plane antenna 130, the hub 140, and the mouse control unit 150 are disposed in the mouse housing 110.

The hub 140 has a first port 142 and a second port 144. The first port 142 connects to the mouse control unit 150. The second port 144 connects to the digital tuner 120. The hub 140 itself connects to a universal serial bus (USB) socket of a computer, thus the computer can electrically connect to the digital tuner 120 and the mouse control unit 150 via the 1-to-2 hub 120 of the mouse 100. The computer can be a notebook computer or a desktop computer without TV card built within.

The plane antenna 130 is connected to the digital tuner 120. The plane antenna 130 receives digital television signal and the plane antenna 130 transmits the digital television signal to the digital tuner 120 for tuning. The mouse 100 includes a vent hole 112 disposed on the mouse casing 110 and arranged near the digital tuner 120. The heat generated from the digital tuner 120 can be diffused via the vent hole 112. The vent hole 112 can be disposed on the top or the side of the mouse casing 110. The digital tuner 120 is connected to a decoder to decode the digital signal into a video data, such as MPEG 2, MPEG 4, etc. The decoder can be disposed in the mouse 100 or in the computer.

The plane antenna 130 may comprise a substrate and a metal layer. The metal layer is disposed on the substrate. The substrate of the plane antenna 130 can be a plastic film or a printed circuit board. The metal layer can be placed on the plastic film or the printed circuit board. The plane antenna 130 may be a metal board. The signal receiving efficiency of the mouse 100 can be improved by the plane antenna 130, which has larger area than the conventional antenna. However, the antenna of the mouse 100 is not limited to the plane antenna 130. The antenna of the mouse 100 can be any type of antenna, which can receive the digital television signal.

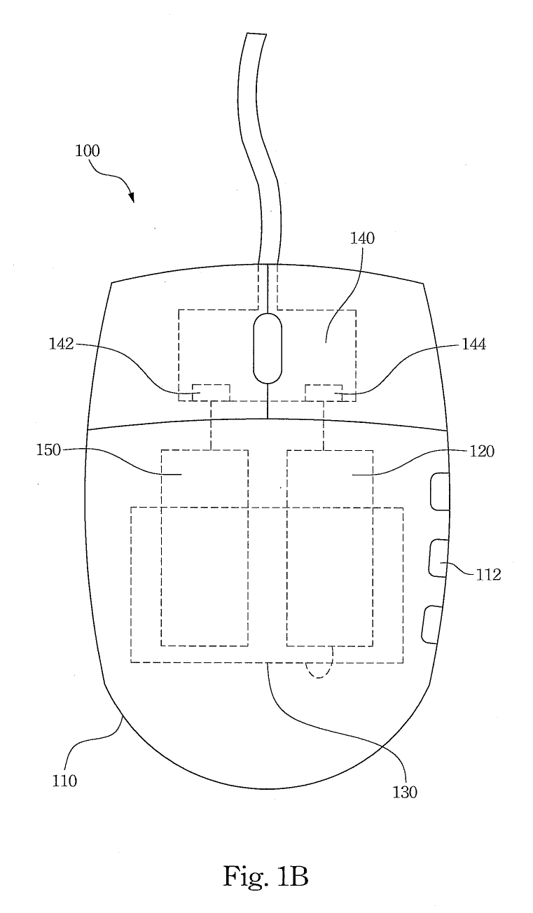

Refer to FIG. 2. FIG. 2 illustrates a schematic diagram of a second embodiment of the mouse with television signal receiving function of the invention. To prevent particles from falling into the mouse 100 via the vent hole 12 and protecting the components in the mouse casing 110, the mouse 100 further includes a slide cover 160 coupled to the mouse casing 110. The slide cover 160 has a slide piece 162. The mouse casing 110 has a slide rail 114. The slide piece 162 of the cover 160 can slide in the slide rail 114 of the mouse casing 110. The slide cover 160 can be disposed covering the vent hole 112 to hide the vent hole 112. The slide cover 160 can be slid and exposing the vent hole 112 for better cooling efficiency.

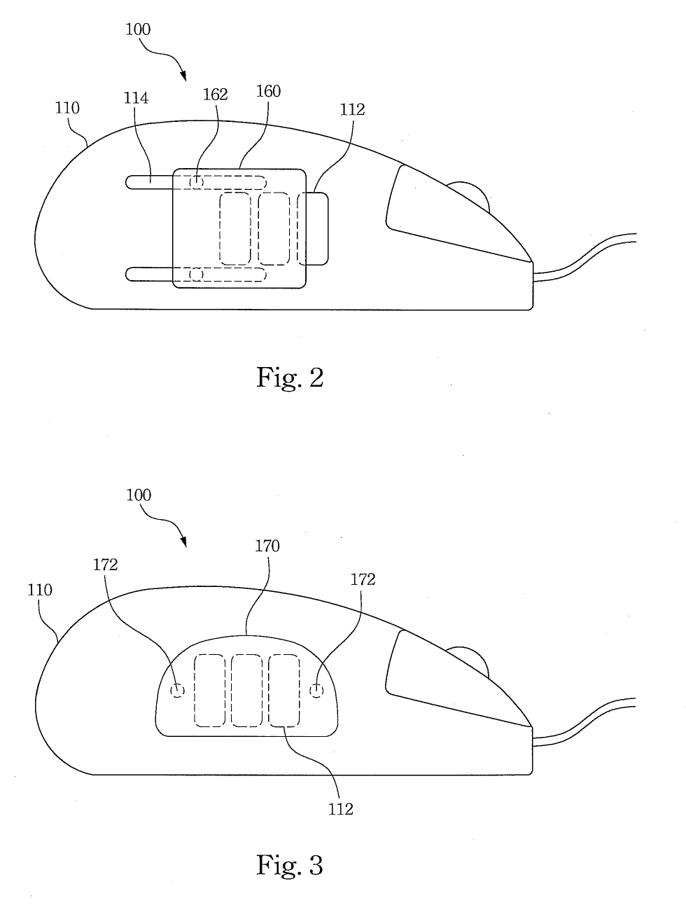

Refer to FIG. 3. FIG. 3 illustrates a schematic diagram of a third embodiment of the mouse with television signal receiving function of the invention. The mouse 100 further includes a detachable cover 170 coupled to the mouse casing 110. The detachable cover 170 has a wedge 172 to couple to the mouse casing 110. The detachable cover 170 can couple to the mouse casing to cover the vent hole 112. The detachable cover 170 can removed to expose the vent hole 112 for better cooling efficiency.

The slide cover 160 or the detachable cover 170 can cover the vent hole 112 when the weather is cold, and the heat generated from the digital tuner 120 can be retained in the mouse casing 110 and further conducted to user's hand. The vent hole 112 can be exposed by removing the detachable cover 170 or sliding the slide cover 160 when the weather is hot.

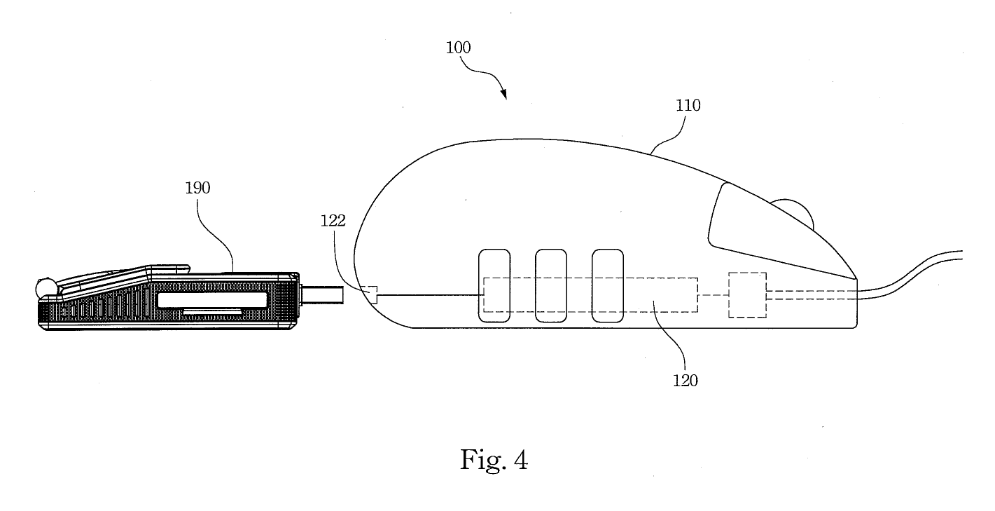

Refer to FIG. 4. FIG. 4 illustrates a schematic diagram of a fourth embodiment of the mouse with television signal receiving function of the invention. The digital tuner 120 further includes a third port 122 disposed exposing the mouse casing 110. The mouse 100 further includes a detachable antenna 190. The detachable antenna 190 can couple to the third port 122 of the digital tuner 120 to improve signal receiving ability when the digital television signal is weak.

The digital tuner and the antenna for receiving the digital television signal can be integrated in the mouse, which is easily carried, thus the space and weight of the television card or the television box can be omitted. The mouse with television signal receiving function has the 1-to-2 hub to connect the digital tuner, the mouse control unit, and the computer, therefore the mouse can receive the television signal and operate normally. The vent hole of the mouse can diffuse the heat generated from the digital tuner.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mouse with television signal receiving function comprising:
a mouse casing;
a digital tuner disposed in the mouse casing;
a vent hole disposed on the mouse casing and arranged near the digital tuner;
an antenna disposed in the mouse casing and connecting to the digital tuner for receiving a digital television signal;
a hub disposed in the mouse casing and having a first port and a second port, wherein the first port is connected with a mouse control unit, the second port is connected with the digital tuner.

2. The mouse with television signal receiving function of claim 1, further comprising a slide cover coupled to the mouse casing for exposing or covering the vent hole.

3. The mouse with television signal receiving function of claim 1, further comprising a detachable cover coupled to the mouse casing for exposing or covering the vent hole.

4. The mouse with television signal receiving function of claim 1, wherein the antenna is a plane antenna.

5. The mouse with television signal receiving function of claim 4, wherein the plane antenna comprises a substrate, and a metal layer disposed on the substrate.

6. The mouse with television signal receiving function of claim 5, wherein the substrate is a plastic film.

7. The mouse with television signal receiving function of claim 5, wherein the substrate is a printed circuit board.

8. The mouse with television signal receiving function of claim 4, wherein the plane antenna comprises a metal board.

9. The mouse with television signal receiving function of claim 1, wherein the hub connects to a universal serial bus socket of a computer.

10. The mouse with television signal receiving function of claim 9, wherein the computer is a notebook computer.

11. The mouse with television signal receiving function of claim 1, wherein the digital tuner comprises a third port disposed exposing the mouse casing.

12. The mouse with television signal receiving function of claim 11, further comprising a detachable antenna connecting to the third port.
